(19) United States
(12) Patent Application Publication
(10) Pub. No.: US 2026/0254122 A1
(43) Pub. Date: Aug. 27, 2026

(54) COMMUNICATIONS SYSTEM OF A VEHICLE

(71) Applicant: AGC GLASS EUROPE, Louvain-la-Neuve (BE)

(72) Inventors: Rémi SARKIS, Gosselies (BE); Xavier DARDENNE, Gosselies (BE); Marguerita ELIAS, Gosselies (BE)

(73) Assignee: AGC GLASS EUROPE, Louvain-la-Neuve (BE)

(21) Appl. No.: 19/129,174

(22) PCT Filed: Nov. 6, 2023
(86) PCT No.: PCT/EP2023/080870

§ 371 Date: May 12, 2025

(30) Foreign Application Priority Data
Dec. 16, 2022 (EP) 22214081

(51) Int. Cl. H01Q 15/00; H01Q 1/12; H01Q 5/25; H01Q 25/00

(52) U.S. Cl. CPC H01Q 15/0013; H01Q 5/25; H01Q 25/005; H01Q 1/1271

(57) ABSTRACT

A method for decoating a glazing unit made of a glass panel with a glass sheet which is low in reflectance for RF radiation, where the glass panel has a bent portion with an axis of curvature. The glazing unit also has a coating system which is high in reflectance for RF radiation disposed on the glass sheet over part of the bent portion. The decoating method includes decoating a frequency selective surface on the coating system by decoating a matrix of decoated grids connected two-by-two and edge-to-edge; each of the decoated grids has decoated regions in the form of grid lines arranged in a mesh; each of the decoated grids is rectangular; the decoating is performed using a laser apparatus. Each of the decoated grids is inscribed in a specific rectangle paralleled to the axis of curvature. Each of the decoated grids is oriented by an angle αmn.

### FIELD OF THE INVENTION

The present invention relates to a communication module for glass applications. The present invention relates to a module, placed on a vehicle glazing, comprising at least one antenna, but preferably two antennas, to be used for both outdoor localization/ranging and indoor presence detection especially relevant in automotive industry. The targeted application for this invention is the localization around vehicles, as well as presence detection inside the vehicle. More specifically the use cases of the present invention relates to a vehicle communication module used for detecting a live body inside the vehicle or a crack on the glazing and locating an user around the vehicle. Even more the present invention relates specifically to a secure and reliable communication module for a vehicle. Furthermore specifically, the subject-matter of the invention relates to a vehicle communication module that uses ultra-wide-band (UWB) antennas for applications, such as but not limited to digital key, keyless entry, child detection inside the vehicle, handsfree trunk access, driver fatigue monitoring, e-toll payments, crack detection on the glazing and etc.

### BACKGROUND OF THE INVENTION

First systems used for determination of location of a vehicle began in the 1970s. Nowadays such location services improved and GPS navigation units are practically standard vehicle equipment and also have applications in many other fields. Commonly used GNSS technologies are not able to provide very accurate results in specific applications needed precise and accurate location/position information. In such cases, GPS based systems should be supported by other solutions. Ultra-wide-band (UWB) technology is a promising technology for precise and accurate positioning purposes due to its wide signal bandwidth. UWB solutions already in the market offer a positioning uncertainty less than several centimeters.

UWB technology finds many other applications in automotive industry because it allows communications for localization, locating, ranging or tracking services with high bandwidth (>500 MHz) and with low energy and in a secure way. For example, UWB antennas facing inside of a vehicle provides detection of a live body inside the car, which allows driving assisting services to follow and monitor driver's condition or detecting the presence of a child inside the vehicle. It works as an UWB device inside the car sending pulse towards typical passenger locations, and checking the reflected signal, effectively working as a monostatic radar. Changes in the received signals are correlated to the typical changes that would be expected from a human breathing and can trigger a warning if a human presence is detected. Moreover, with at least three UWB anchors provided on a vehicle, presence and localization of a user with a UWB transmitter such as a smartphone can be detected in short range and a secure keyless entry can be achieved. Typical application is known as “phone as a key”, modern phones are now equipped with UWB antennas, which can communicate with on vehicles UWB anchors. This communication enables accurate ranging of the phone with respect to each anchor, by time of flight (TOF) measurement of the UWB pulses. As soon as the phone range can be computed with respect to at least 3 UWB anchors, the exact location of the phone can be established. Then, when the phone gets in close proximity of a door or trunk, the vehicle can be automatically unlocked. The use cases for UWB antennas/anchors on the vehicle are not limited and can be increased to many other applications.

Although such technologies offer a variety of useful services and applications, there are still many challenges to overcome. Some of those challenges are firstly the availability of antenna locations on a vehicle is limited where vehicle bodies are mainly covered by metal chassis and priority of design is for the aerodynamics and aesthetics of the vehicle, secondly integration of separate RF systems are complex where performance might be affected inversely, and thirdly cost of addition of components is high where merely the premium vehicles can have such systems.

For vehicle applications, metal body of a vehicle acts as a blocker for RF signals and resulting addition of more antenna components. In order to get accurate localization of an UWB phone outside the car, the latter should be in line of sight (LOS) with at least three UWB anchors on the car. But with the typical locations used (bumpers, door handles), and because of the shadowing effect of the metallic car body, this LOS condition can only be fulfilled with typically at least 4 to 6 UWB anchors or maybe more. The achievable coverage cannot exceed 180°, at most. Hence there is a need of much more anchors at different locations. Current typical automotive UWB systems comprise, several (typically 4-6) UWB devices located around the vehicle, outside of the metallic car body (e.g. front and rear bumpers, door handles, shark fin, . . . ), used for outdoor localization/ranging. One or several UWB devices located inside the vehicle (e.g. roof) used for indoor presence detection. Therefore, many UWB antennas (mainly 5 to 10) are needed for an efficient operation.

It is also a big challenge to operate such many antennas with the other radio systems and antennas provided in the vehicle. The interference among the RF signals causes a decrease in the performance and also noise in the signal received, therefore a means to separate the different RF signals needed. It can be achieved by locating the antennas far apart from each other, however in that case line of sight condition will be difficult to fulfill. These two problem can be solved by high cost solutions, like many antennas provided in the vehicle and many elements to prevent the interference and so on.

However, with rapid growth in the demand for vehicle electronics, more and more communication modules needed for connections to vehicle and the said challenges limit manufacturers. Especially the complexity of many systems working together seamlessly in the vehicle limits availability of various applications and increases the cost. There is clear need for simple communication modules that have less parts to overcome the complexity and interference problems and also to bear the costs.

Although various alternatives proposed as communication modules for vehicles including UWB anchors, such developments have little applicability in terms of costs. For example, European Patent No. EP3982343 and EP3981670 disclose a communication module for a vehicle including at least one UWB antenna. The said module can be placed in the bumpers, side mirrors or on top of the vehicle as inside a shark-fin element for outdoor ranging applications.

For example, International Patent Application No. WO2022074189 also discloses a communication module for a vehicle including at least one UWB antenna. The said module can be placed inside the vehicle, especially under the roof for indoor detection applications.

For example, Chinese Patent No. CN106205136 discloses a vehicle positioning system based on UWB technology and antennas.

For example, Chinese Patent No. CN108216121 discloses a secure entry system for a vehicle based on UWB technology and antennas.

For example, U.S. Pat. No. 9,689,982 discloses an object detection device for a vehicle, located in the rear of the vehicle and utilizes UWB technology.

Although the problem of establishing a rigid operation has been partially solved in cited prior art, there is still a need for a cheap and simple and also compact solution which also enables better performance than the current applications in a cost efficient manner.

Thus, there remains a clear need of finding an appropriate replacement to conventional UWB systems located in many different locations of a vehicle for a more stable, steady, compact and cost-efficient alternative. Underlying motivation is to improve the performance of the UWB systems and to decrease the cost of the UWB systems, and further develop such a module operating with less antennas used and without degradation for a long lasting operation, and further ability to connect more antennas, more RF systems to the glass substrate, and further facilitate more applications for vehicles by improving utilization efficiency.

### SUMMARY OF THE INVENTION

The present invention provides a vehicle communication module for a glazing. The module includes a dielectric substrate, such as a printed circuit board to be fixed/attached to the glazing. The present invention also provides a module including at least two antennas and a vehicle including the module. The present invention relates, in another aspect, to usage of such a module in localization/ranging applications in and out of the vehicle. The present invention also relates, in another aspect, to utilization of a such module in automotive industry. The module is operatively connected to and in electrical communication with an electronic device of the vehicle for transferring and receiving RF signals and/or information.

The module of the present invention is suitable for a glazing comprising a substrate formed from glass and the module is to be attached or fixed to the glazing. And in different embodiments, the module may comprise at least a housing which encapsulates the dielectric substrate of the module and enabling the module to be protected, and may also comprise a control circuit, such as controlling electronics, including RF front-end, amplifiers, signal generation and reception devices, signal processing, I/O devices and etc. processing the RF signals received/transmitted from/to the antennas and may also comprise a switch for passing from one antenna to other. Depending on the intended applications, the vehicle may be equipped with more modules.

The module of the present invention provides at least two antennas by simply one module fixed to the glass surface. The first antenna can work as communicating the outside of the vehicle, and the second antenna can work as communicating the inside of the vehicle. More precisely, the first antenna is an omnidirectional antenna to maximize coverage around the vehicle, and the second antenna is a higher gain antenna to increase sensitivity inside the vehicle. In a version of the present invention the antennas are being Ultra-Wide-Band (UWB) antennas, specifically working from 3.1 to 10.6 GHz range having at least 500 MHz bandwidth. Both of the antennas are provided on the dielectric substrate and they may be located on/in the dielectric substrate, which allows flexibility for the invention. In different embodiments, a reflector above the second antenna may be provided between the second antenna and the outside glazing surface. It can, for instance, be a reflective layer inside the dielectric substrate, in the interface of dielectric substrate and glazing, or inside a laminated glazing, to enable the second antenna to focus mainly to the interior of the vehicle by helping to increase the gain of the antenna in the desired directions. The reflector may be printed on the glazing, which provides more flexibility for the present invention. Another optional reflector may be provided for the first antenna to enable the first antenna to focus exterior of the vehicle by locating the optional reflector below the first antenna to direct the radiation to the exterior of the vehicle, such that the optional reflector for the first antenna may be located on/in the dielectric substrate or on the housing encapsulating the dielectric substrate.

The present invention may also relate to a complete communication module for a vehicle which also comprises the control circuits for the antennas and the control circuit may also comprise a switch for switching signals between the two antennas and even a connection outlet for the connectors. Therefore, the present invention provides a plug&play solution of a complete module that can be installed easily onto the glazings. The present invention relates, in another aspect, to usage of such communication modules on vehicle glazings. In different embodiments of the present invention, the complete communication module comprising the antennas, the control circuit and the switch work in the Ultra-Wide-Band (UWB) frequency range.

A first main advantage of this invention is that, by locating the antennas/anchors on vehicle glazing, they can benefit from both the glazing electromagnetic (EM) transparency, and a higher location above ground, providing much less shadowing by the metallic car body. Thus, the present invention allows almost 360 degree coverage around the vehicle with less number of antennas. Therefore, the number of needed anchors/antennas on the vehicle can be significantly reduced.

The second main advantage of this invention is that thanks to the glazing location, each module could cover both outdoor and indoor applications. Indeed, an UWB anchor located in a bumper has no LOS to the vehicle interior, while a device placed on a windshield, a backlite, or a quarterlite, can have LOS with both outside and inside locations. Therefore, the present invention allows a communication module which is able to combine indoor and outdoor applications in one module.

By combining two antennas in a single module, located on vehicle glazing, this single module could cover both indoor and outdoor applications, hence decreasing the overall number of required UWB anchors, specifically the number of antennas can be reduced by 50%. For example, 360 degree coverage around the car and live body detection for all seats can be achieved by 4 communication modules of the present invention.

The present invention further concerns providing a unique (tailor-made) solution for glass substrates in automotive industry such as vehicle comprising such a communication module comprising at least two antennas for both outdoor and indoor applications.

### BRIEF DESCRIPTION OF THE DRAWINGS

The invention will now be described further, by way of examples, with reference to the accompanying drawings, wherein like reference numerals refer to like elements in the various figures. These examples are provided by way of illustration and not of limitation. The drawings are a schematic representation and not true to scale. The drawings do not restrict the invention in any way. More advantages will be explained with examples.

FIG. 1 illustrates a top view of vehicle and showing potential locations for installing the module of the present invention such as the glass roof, windshield or the backlite, while FIG. 2 to FIG. 5 illustrate the different embodiments of the present invention.

The elements illustrated in the figures are numbered as follows:
1. Vehicle communication module
2. First antenna
3. Dielectric substrate
31. First surface
32. Second surface
33. Interlayer
331. First interlayer surface
332. Second interlayer surface
4. Second antenna
5. First reflector
6. Second reflector
7. Housing
G. Glazing
F1. First face
F2. Second face
Fi. Interlayer
Fi1. First interlayer face
Fi2. Second interlayer face

### DETAILED DESCRIPTION OF ILLUSTRATIVE EMBODIMENTS

The present invention will be described with respect to particular embodiments and with reference to certain drawings but the invention is not limited thereto but only by the claims.

While some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

As used herein, spatial or directional terms, such as “inner”, “outer”, “above”, “below”, “top”, “bottom”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims are approximations that can vary depending upon the desired properties sought to be obtained by the present invention. In the following description, unless otherwise specified, expression “substantially” mean to within 10%, preferably to within 5%.

Moreover, all ranges disclosed herein are to be understood to be inclusive of the beginning and ending range values and to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Further, as used herein, the terms “deposited over” or “provided over” mean deposited or provided on but not necessarily in surface contact with. For example, a coating “deposited over” a substrate does not preclude the presence of one or more other coating films of the same or different composition located between the deposited coating and the substrate.

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated. In this document, “configured to (or set to)” may be interchangeably used in hardware and software with, for example, “appropriate to”, “having a capability to”, “changed to”, “made to”, “capable of”, or “designed to” according to a situation. In any situation, an expression “device configured to do” may mean that the device “can do” together with another device or component.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein. When it is described that a constituent element (e.g., a first constituent element) is “(functionally or communicatively) coupled to” or is “connected to” another constituent element (e.g., a second constituent element), it should be understood that the constituent element may be directly connected to the another constituent element or may be connected to the another constituent element through another constituent element (e.g., a third constituent element).

“connector” and “electrical connector” and “electrically conductive connector” are used interchangeably throughout the text. “pane” and “window pane” and “glass pane” and “glazing” and “laminated glazing” are used interchangeably throughout the text. “in electrical communication” or “in an electrically communicated manner” throughout the text is to be understood as electrical current can flow between the mentioned two elements regardless of having an actual physical contact. “module” and “communication module” and “vehicle communication module” are used interchangeably throughout the text. “antenna” and “anchor” and “antenna element” are used interchangeably throughout the text.

Referring the figures, wherein like numerals indicate like or corresponding parts throughout the several views, a pane (G) is generally shown per se and it can be utilized on a vehicle or alike, comprising a first face (F1) facing the exterior of the vehicle, and a second face (F2) facing the interior of the vehicle. Directions from interior to exterior should be understood as in the direction almost perpendicular to the glazing surface, therefore term “top” is to be understood as towards to exterior of the vehicle in the perpendicular direction of the glazing surface, and the term “below” is to be understood as towards to interior of the vehicle in the perpendicular direction of the glazing surface, i.e., from top to below, the faces (F1, F2) of the glazing (G) are in order of first face (F1) and second face (F2), in other words, bottom/lower/below are referred towards to interior of the vehicle, top/higher/above are referred towards to exterior of the vehicle. The pane (G) comprises a substrate preferably formed from glass. The glass substrate is further defined as an automotive glass but not limited to. In a preferred embodiment, the automotive glass is further defined as soda lime silica glass, which is well known for use in window panes (G) of vehicles. However, it is to be appreciated that the glass may be any type of glass composition or in any shape that is known in the art like the borosilicate, quartz, flat or curved or float or etc.

The present invention proposes a communication module (1) to a pane (G) formed from glass to be utilized in a vehicle and more preferably on a laminated glazing (G) but not limited to. A vehicle should be understood as any conveyor that transfers anything from point a to point b which includes any land, air or sea vehicles like car, van, lorry, motorbike, bus, tram, train, drone, airplane, helicopter and the like.

A laminated glazing (G) refers to at least two sheets of glass being laminated with an interlayer. The sheets of glass can be made of (mineral) glass, more specifically a silica-based glass, such as soda-lime-silica, alumino-silicate or boro-silicate type glass. The interlayer is usually made of polyvinyl butyral (PVB) or ethylene-vinyl acetate (EVA). In the case of laminated glass used as glazing (G), the glazing (G) comprises an interlayer (Fi) and the interlayer (Fi) having two faces, namely first interlayer face (Fi1) and second interlayer face (Fi2) and the interlayer faces (Fi1, Fi2) may be utilized for the sake of present invention. In the case of laminated glazing (G), from top to below, the faces (F1, F2, Fi1, Fi2) of the glazing (G) are in order of first face (F1), first interlayer face (Fi1), second interlayer face (Fi2) and second face (F2). However, as mentioned above the present invention is not limited to laminated glazings.

In another embodiment of the present invention, the substrate material is an amorphous substance in the form of flat long plate or curved glass sheet or glass sheet coated with electrically conductive coating as on one or more of its faces (F1, F2, Fi1, Fi2) to facilitate a function, such as UV reduction, heating or defogging/defrosting but not limited to. In the case of a conductive coating on the glazing (G), the module (1) of the present invention is deployed in an uncoated region of the glazing (G) or a de-coating process needed where the module is to be fixed for an operation with better performance.

In other embodiments, the conductive coating on the glazing (G) may be screen printed or deposited by physical or chemical vapor deposition techniques or simply painted on the surface(s) of the substrate. In some other embodiments, the conductive coating may comprise one or more of the following materials such as but not limited to C, Graphene, Ag, Au, Cu, Ni, Al, Ti, Cr, Fe, V or W.

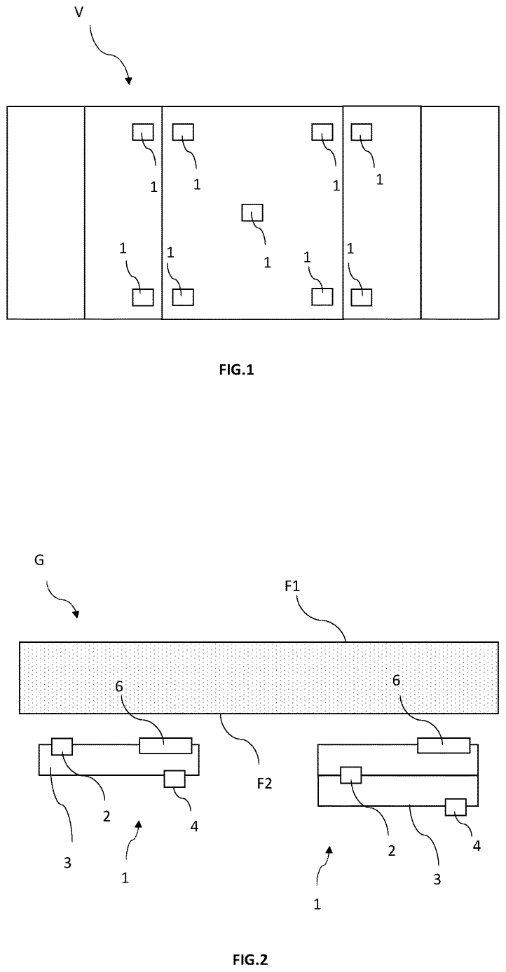

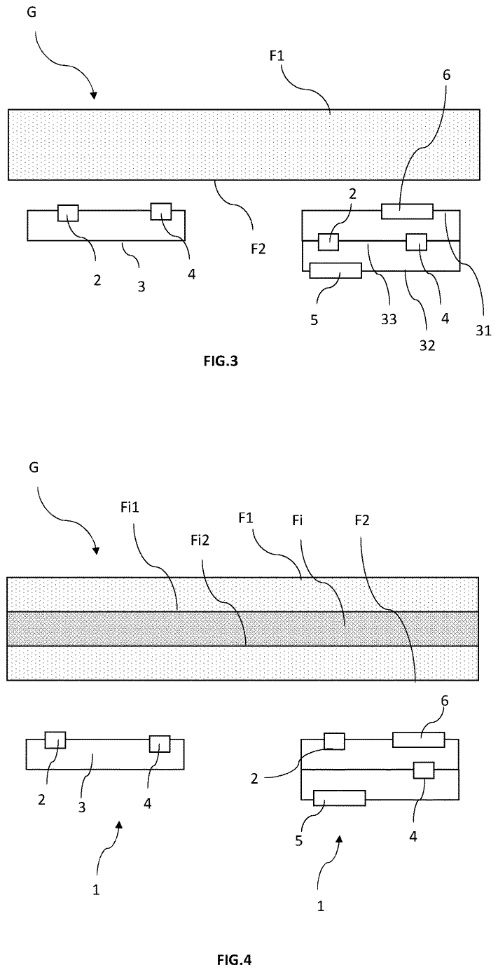

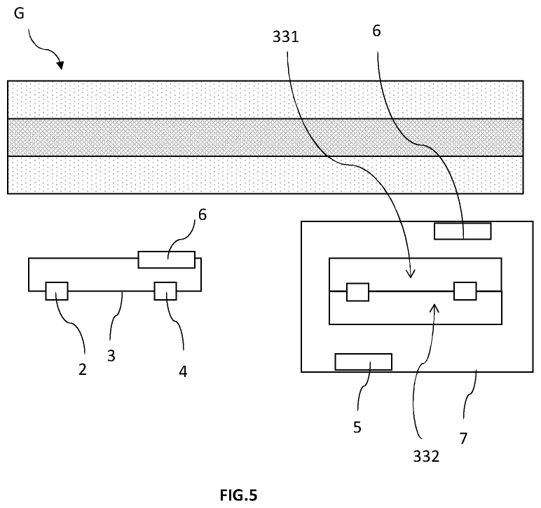

Referring to FIG. 1, a communication module (1) is operatively attached to a glazing (G) and in electrical communication with an electronics device, like the ECU (electronic control unit). FIG. 1 illustrates some potential locations which the module (1) of the present invention could be installed and but not limited to. It should be understood that the module (1) of the present invention is suitable for any glazing (G) in the vehicle. The current or signal/data is carried over electrically conductive cables (not shown in the figures) which are in electrical communication with the module (1) of the present invention. In different embodiments of the present invention, the glazing (G) can be the windshield, backlite, sidelites, quarterlite or the roof of the vehicle. For the sake of the invention, the glazing (G) is any type of glass surface, such as laminated, tempered or else.

In different embodiments of the present invention, the vehicle communication module (1) may be fixed to the edge of the glazing (G), mainly to the area where black enamel print exists to avoid distracting the driver or the users of the vehicle. However, the location on the glazing (G) where the module (1) is fixed or attached is not decisive on the operation of the present invention.

The vehicle communication module (1) of the present invention is for a glazing (G) having the first face (F1) facing the exterior of the vehicle and the second face (F2) facing the interior of the vehicle, comprising a dielectric substrate (3) to be fixed to the second face (F2) of the glazing (G) and the dielectric substrate (3) is substantially parallel to the glazing (G), having a first surface (31) facing the glazing and a second surface (32) facing the interior of vehicle, wherein at least one first antenna (2) radiating mainly around the vehicle for ranging/localizing applications around the vehicle and a second antenna (4) radiating mainly inside the vehicle for ranging/detecting applications inside the vehicle, provided on the dielectric substrate (3), further wherein the first antenna (2) is on the same level or higher than the second antenna (4) in the direction of interior to exterior. The module (1) is attached to second face (F2) of the glazing (G), this has to be understood that the module (1), in some embodiments the dielectric substrate (3) itself, is secured/attached/binded to the glazing (G) in any conventional method, such as gluing, clipping and etc. that the module (1) stays close to the glazing (G) surface after installation. The vehicle communication module (1) comprises the first antenna (2), the first antenna (2) is used for localization/detection/ranging applications of bodies around the vehicle, preferably the first antenna (2) is a omni-directional antenna that can radiate considerably in any direction to cover almost 360° around the vehicle, therefore the first antenna (2) radiating mainly around the vehicle should be understood in that sense. The second antenna (4) is used for detecting/monitoring a live body inside the vehicle, preferably the second antenna (4) is focused only inside of the vehicle with high gain, therefore the second antenna (4) radiating mainly inside the vehicle should be understood in that sense. The antennas (2, 4) are provided side-by-side with each other on the dielectric substrate (3), i.e., the antennas (2, 4) are not overlapping with each other in the direction of parallel to the surface of glazing (G). Moreover, the antennas (2, 4) are preferably also not overlapping in the vertical axis of interior to exterior direction. Since the first antenna (2) is specified/used for outside applications and the second antenna (4) is specified/used for inside applications, the first antenna (2) is provided on the same level or higher than the second antenna (4) in the direction of interior to exterior. Such positioning of the antennas (2, 4) may help coupling/correlation between the antennas (2, 4) to be minimized. In a preferred embodiment, antennas (2, 4) are planar antennas on/in the dielectric substrate (3). The dielectric substrate (3) may be a printed circuit board or such suitable means known conventionally.

It is understood that the exterior or exterior of the vehicle is outside of the vehicle and interior or interior of the vehicle is inside of the vehicle. When a direction is defined on the dielectric substrate (3), it should also be understood that the bottom/lower of the dielectric substrate (3) towards to interior and top/higher of the dielectric substrate (3) towards to exterior, and the glazing (G) surface is almost perpendicular to the interior—exterior direction.

In one embodiment of the present invention, the dielectric substrate (3) comprises at least one interlayer (33) between its first and second surface (31, 32) and the interlayer (33) having two surfaces, namely the first interlayer surface (331) and the second interlayer surface (332). From top to bottom, the surfaces of the dielectric substrate (3) are in order of first surface (31), first interlayer surface (331), second interlayer surface (332) and second surface (32). The antennas (2, 4) may be located/printed on the interlayer (33) surfaces (331, 332) of the dielectric substrate (3), in other words, the antennas (2, 4) may be provided in the dielectric substrate (3). Utilization of the interlayer (33) of the dielectric substrate (3) allows flexibility for achieving the first antenna (2) being on higher level than the second antenna (4). The interlayer (33) may also be used to achieve 3D antennas if needed for the specific application.

In one embodiment of the present invention, the module (1) comprises more than one first antenna (2) provided as the first antenna (2) to improve the coverage for outdoor applications. In another version of this embodiment, the first antenna (2) may be an antenna array. This embodiment also provides a reduction in the number of antennas (2) needed for outdoor applications by allowing a larger coverage.

In one embodiment of the present invention, the first antenna (2) and the second antenna (4) are provided on the second surface (32) of the dielectric substrate (3). The antennas (2, 4) are printed/provided in any conventional way onto the dielectric substrate (3) to make the module (1) working stand-alone. In this embodiment, ease of production is achieved by printing both antennas (2, 4) on the second surface (32) of the dielectric substrate (3), the naked dielectric substrate (3) may be fixed onto the second face (F2) of the glazing (G) without the need of a housing, i.e., the first surface (31) of the dielectric substrate (3) may be fixed to the second face (F2) of the glazing (G) while the antennas (2, 4) are resting on the second surface (32) of the dielectric substrate (3). By this embodiment, the antennas (2, 4) are also protected from humidity and water caused by condensation on the second face (F2) of the glazing (G).

In other embodiments of the present invention, the first antenna (2) is provided on the first surface (31) of the dielectric substrate (3) and the second antenna (4) is provided between the first surface (31) and the second surface (32) of the dielectric substrate (3), namely on first surface (31) or first interlayer surface (331) or second interlayer surface (332) or second surface (32). To be able to make the line of sight of the first antenna (2) more transparent electromagnetically, the first antenna (2) is employed in the glazing (G)—dielectric substrate (3) interface, i.e., the first surface (31) of the dielectric substrate (3). In a version of this embodiment, the second antenna (4) provided on the first surface (31) of the dielectric substrate (3). In a different version of this embodiment, the second antenna (4) provided on the interlayer (33) of the dielectric substrate (3). In a different version of this embodiment, the second antenna (4) provided on the second surface (32) of the dielectric substrate (3). Such flexibility and freedom for allocating the second antenna (4) also allows de-coupling between the antennas (2, 4) and hence an improvement in the performance. Different options representing the flexibility and the freedom in design are represented in FIGS. 2 to 5.

In a different embodiment of the present invention, the first antenna (2) may be provided on the glazing (G), namely on the second face (F2) or on the interlayer faces (Fi1, Fi2) of the glazing (G). The first antenna (2) is printed in any conventional way onto the glazing (G). Although the present invention proposes a stand-alone module (1) with both antennas (2, 4) provided on the dielectric substrate (3), with this embodiment, already existing antenna systems on glazing (G) can be converted to a vehicle communication module (1) of the present invention, such that the dielectric substrate (3) with the second antenna (4) is fixed right below the first antenna (2) on the glazing (G).

In another embodiment of the present invention, the first antenna (2) is provided on the interlayer surfaces (331, 332) of the dielectric substrate (3) and the second antenna (4) can be provided on the interlayer surfaces (331, 332) or on the second surface (32) of the dielectric substrate (3). In this embodiment, the first antenna (2) may be provided on either the first interlayer surface (331) or the second interlayer surface (332) of the dielectric substrate (3), and the second antenna (4) may be provided on the first interlayer surface (331) or the second interlayer surface (332) or the second surface (32) of the dielectric substrate (3), and provided that the first antenna (2) is on the same level or higher than the second antenna (4), i.e., when the first antenna (2) is provided on the second interlayer surface (332), there is two options for the second antenna (4), one is the second interlayer surface (332) and the other is second surface (32) of the dielectric substrate (3).

In some other embodiments of the present invention, the module (1) comprises a first reflector (5) provided beneath the first antenna (2) in the direction of interior to exterior. The first reflector (5) can be made of any conductive material, such as copper, silver, silver paste, or any other. The first reflector (5) prevents indoor radiation of the first antenna (2), and helps increasing the coverage of the first antenna (2) in the desired directions. In a version of this embodiment, the first reflector (5) provided on the second surface (32) of the dielectric substrate (3) or in the interlayer surfaces (331, 332) of the dielectric substrate (3), aligned with the first antenna (2) in the vertical axis, i.e., the axis extending from interior to exterior of vehicle which is also almost perpendicular to the glazing (G) surface as described above, and also provided that the first antenna (2) is above the first reflector (5). The area of the first reflector (5) may be bigger than the area of the first antenna (2).

In another embodiment, the module (1) comprises a second reflector (6) over the second antenna (4) in the direction of interior to exterior. The second reflector (6) can be made of any conductive material, such as copper, silver, silver paste, or any other. The second reflector (6) prevents outdoor radiation of the second antenna (4), and helps increasing the gain of the second antenna (4) in the desired directions. In a version of this embodiment, the second reflector (6) provided on the faces (F1, Fi1, Fi2, F2) of the glazing (G), aligned with the second antenna (4) in the vertical axis, i.e., the axis almost perpendicular to the glazing (G) surface. In another version of this embodiment, the second reflector (6) provided on the first surface (31) or the interlayer surfaces (331, 332) of the dielectric substrate (3), aligned with the second antenna (4) in the vertical axis. Possibility of providing the second reflector (6) in many different surfaces (F1, Fi1, Fi2, F2, 31, 331, 332) provides flexibility for the invention. The area of the second reflector (6) may be bigger than the area of the second antenna (4). Usage of reflectors (5, 6) also helps reducing the mutual coupling between the antennas (2, 4). Both reflectors (5, 6) may also be used as ground plane for the antennas (2, 4), respectively.

Being able to position the reflectors (5, 6) on the different surfaces (31, 32, 331, 332) of the dielectric substrate (3) and other positions (F1, Fi1, Fi2, F2) described above helps to increase the performance of the antennas (2, 4). Mainly, the distance between the antenna (2, 4) and the reflector (5, 6) is at least partially affecting the bandwidth of the antenna (2, 4) in the expense of antenna efficiency, and therefore, the flexibility of the present invention provides achieving antennas (2, 4) with a broader bandwidth and provides the performance of the antennas (2, 4) increase tremendously. In addition, such flexibility allows to provide antennas (2, 4) specified for outdoor and indoor applications to be designed and built next to each other inside a single module (1). Different options representing the flexibility and the freedom in design are represented in FIGS. 2 to 5.

In different embodiments of the present invention, the dielectric substrate (3) is configured in a bendable form that can be bent at least in certain areas for positioning the dielectric substrate (3) on the vehicle glazing (G). Usage of a bendable dielectric substrate (3) allows the vehicle communication module (1) of the present invention to be accommodated to almost any glazing (G), mainly the glazings (G) that have a curvature.

In another version of the present invention, the module (1) comprises a housing (7) encapsulating the dielectric substrate (3). The housing (7) covers at least some portion of the dielectric substrate (3), i.e., the housing (7) covers at least partially the first and second surfaces (31, 32) of the dielectric substrate (3), in some embodiments, the housing (7) may be in the form of a case. The housing (7) protects the module (1) from the environmental effects, like dust, water, humidity and etc. The housing (7) may also be used to enable the fixation of the module (1) onto the glazing (G). For the sake of the nature of the invention, the shape or the material of the housing (7) are not utmost important. In different embodiments of the present invention, the housing (7) is also utilized for allocating the reflectors (5, 6), i.e., the reflectors (5, 6) may be located on the inner or outer surface of the housing (7) depending on the application.

In other embodiments of the present invention, the antennas (2, 4) are configured in the form of a Ultra-Wide-Band (UWB) antenna for a Ultra-Wide-Band (UWB) signal transmission in a Ultra-Wide-Band (UWB) frequency range. In a version this embodiment, the antennas (2, 4) are configured for a Ultra-Wide-Band (UWB) signal transmission in a Ultra-Wide-Band (UWB) frequency band from the frequency range between 30 MHz and 10.6 GHZ, or any particular range inbetween for different embodiments. The Ultra-Wide-Band (UWB) technology quite fits the intended application of the present invention, mainly Ultra-Wide-Band (UWB) technology allows determination of location in a precise manner and also detection of a live body or a crack on the glazing. The antennas (2, 4) can be in any design as long as they can operate in the Ultra-Wide-Band (UWB) frequencies with low and constant group delay values and also with desired bandwidth which is larger than 500 MHZ, and may also be larger than 1 GHz.

In different embodiments of the present invention, the module (1) comprises a control circuit (not shown in the figures) for transmission and reception operation is coupled with the antennas (2, 4), and the antennas (2, 4) are arranged together with the control circuit on the dielectric substrate (3). To be able to achieve better performance of the antennas (2, 4), the control circuit may comprise Ultra-Wide-Band (UWB) controlling electronics, including RF front-end, amplifiers, signal generation and reception devices, signal processing, I/O devices, and etc. Such arrangement allows reduction of the noises, and increases performance of the antennas (2, 4), all the signals received/transmitted through the antennas (2, 4) are processed in the module (1) itself. Moreover, addition of the control circuit into the module (1) makes the module (1) of the present invention more full-fledged. In a version of this embodiment, the control circuit comprising a switch (not shown in the figures) for switching between the first antenna (2) and the second antenna (4). With the switch, the need for two separate control circuit for the two antennas (2, 4) is eliminated. The switch is suitable for switching in high frequency range, for example an HF switch mainly used in the RF fields.

In one embodiment, current/RF/data signal carrying connectors/cables are provided onto the dielectric substrate (3), connectors are soldered to the dielectric substrate (3) in any conventional way. Signals coming from/to antennas (2, 4) are carried over the connectors/cables, i.e., the connectors/cables are the bridge between the vehicle ECU (electronic control unit) and the module (2). In a version of this embodiment, connectors/cables are co-axial connectors/cables or regular data connectors/cables. In a different version of this embodiment, co-axial cables are directly connected to the dielectric substrate (3) by soldering or by any other methods.

As mentioned in the introduction, the present invention finds itself a variety of application areas in a vehicle, such as keyless entry, trunk/boot access, driver fatigue detection, child detection, toll payments, crack detection on the glazings (G). Having at least two Ultra-Wide-Band (UWB) antennas (2, 4) in a single module (1) as the present invention provides allows allocating less Ultra-Wide-Band (UWB) anchors into the vehicle with better 360 degree coverage for outdoor access and indoor sensing and localization applications. Such configurations will be described herein shortly to provide better understanding of the present invention. Some different installation locations for the module (1) are represented in the FIG. 1, the module (1) may also be installed on sidelite or quarterlite of the vehicles.

In one of the embodiment of the present invention, the module (1) is placed on the glass roof of a vehicle, mainly four modules (1) are placed around the corners or the edges of the glass roof. In this embodiment, with just having four Ultra-Wide-Band (UWB) antennas (2) for outdoor applications allows a continuous 360 degree coverage around the vehicle, and therefore detecting and locating a user around the vehicle achieved with just four Ultra-Wide-Band (UWB) anchors. In the meantime, thanks to the present invention, four Ultra-Wide-Band (UWB) antennas (4) facing the interior of the vehicle allows detecting presence of live bodies inside the vehicle. With such an arrangement, the status of the driver can be analyzed and also passengers in the rear seats and front seats can be detected. Therefore, providing a premium connectivity for a vehicle with just four module (1) of the present invention.

Similar to above embodiment, in another embodiment of the present invention, four modules (1) are installed on the windshield and the backlite of the vehicle respectively, two modules (1) on the backlite, around the upper corners and two modules (1) on the windshield, around the upper corners. With such an arrangement, a similar coverage performance to the above embodiment can be achieved for vehicles not having a glass roof. In the case of a glass roof, at least one module (1) may also be installed on the glass roof.

In another embodiment of the present invention, the modules (1) of the present invention deployed on windshield, backlite and the glass roof of the vehicle. Two modules (1) on the backlite, two modules (1) on the windshield and two to four modules (1) on the glass roof of the vehicle. With such an arrangement, a premium performance is achieved for both outdoor access/localization applications and indoor sensing applications. With this embodiment, since all the glazings (G) have a module (1), any cracks on the glass surface can also be sensed.

The present invention also proposes a vehicle comprising at least one module (1) as described previously. In a preferred embodiment, the vehicle comprises more than one module (1) on the glazing (G) or any surface where glass is utilized.

The present invention also proposes the usage of a module (1) with at least two UWB antennas (2, 4) on a glazing (G) of a vehicle as described above in detail for outdoor access/localization applications and indoor sensing applications. As described above in detail that usage of a module (1) on glass surfaces provides usage of less antennas and circuitry elements and etc. which facilitates a very cost effective solution for the said intended applications for any vehicle.

With the module (1) of the present invention, an improvement for the cost reduction of localization and sensing applications is achieved for vehicles comprising at least one glazing (G), therefore such applications can be utilized also in compact or economy vehicles. The module (1) of the present invention provides a stand-alone solution and better utilization of the glazing (G) and enables more antenna systems to be deployed on the glazing (G) in addition to reduction of the needed UWB anchors on the vehicle, that makes compatibility for a wide range of applications on glass surfaces. In general, the module (1) of the present invention is suitable to be used in applications on glass where cost is controversial, more specifically low cost applications with high performance requested, even more specifically when multiple antenna systems required to work together seamlessly.

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

1. A decoating method for decoating a glazing unit, the glazing unit comprising:
a glass panel comprising a glass sheet which is low in reflectance for RF radiation, the glass panel comprising a bent portion with an axis of curvature Acmn;
a coating system which is high in reflectance for RF radiation disposed on the glass sheet over at least a part of the bent portion,
the decoating method comprising:
decoating a frequency selective surface on the coating system by decoating a matrix of decoated grids, Gmn, connected together two-by-two and edge-to-edge; each of the plurality of decoated grids having decoated regions in a form of grid lines arranged in a mesh-like manner; each of the plurality of decoated grids having a rectangular generic shape with a length (LMn) and a width (Wmn); the decoating being performed by using a laser apparatus having a scan field, Lmax, and a zone Rayleigh, Za,
wherein each of the plurality of decoated grids is inscribed in a specific rectangle Rmn having a length LRmn and a width WRmn which is paralleled to the axis of curvature Acmn; each of the plurality of decoated grids being oriented by an angle αmn to the corresponding specific rectangle;
wherein a width Wmn
$$Wmn = \frac{WRmn * cos α mn - LRmn * sin α mn}{( {cos}^{2} α mn - {sin}^{2} α mn )}$$
wherein a length Lmn
$$Lmn = \frac{LRmn - Wmn * sin α mn}{cos α mn}$$
and wherein:
WRmn is from 50% up to 100% of a minimum between Lmax and Wr wherein Wr=2*sqrt(2*Za*Rmn−Za²);
LRmn is from 50% up to 100% of Lmax;
Rmn corresponds to a radius of the glass sheet at the corresponding specific rectangle of a decoated grid Gmn measured in an axis of the length; and
αmn≠kπ/2 wherein k is an odd number.

2. The decoating method according to claim 1, where WRmn is from 80% up to 100% of a minimum between Lmax and Wr wherein Wr=2*sqrt(2*Za*Rmn−Za²).

3. The decoating method according to claim 1, wherein LRmn is from 80% up to 100% of Lmax.

4. The decoating method according to claim 1, wherein each of the αmn are equals to a same angle α11.

5. The decoating method according to claim 4, where α11 is substantially equal to 0.

6. The decoating method according to claim 1, wherein the laser apparatus comprises a F-theta lens.

7. The decoating method according to claim 1, wherein the laser apparatus comprises a galvo head designed to orientate the laser beam.

8. The decoating method according to claim 1, wherein some of the plurality of the decoated grids comprises a rake design at an edge.

9. The decoating method according to claim 8, wherein each of the plurality of the decoated grids comprises a rake design on an edge.

10. The decoating method according to claim 9, wherein each of the plurality of the decoated grid comprises a rake design at every edge.

11. The decoating method according to claim 1, wherein the decoating is performed in a factory.

12. The decoating method according to claim 1, wherein the decoating is performed in situ.

13. The decoating method according to claim 1, wherein the glass sheet further comprising a flat portion.

14. A partially decoated glazing unit produced by the decoating method according to claim 1.

15. A decoating apparatus to partially decoat a glazing unit using the method according to claim 1.

16. The decoating method according to claim 2, wherein Lmn is from 90% up to 100% of the minimum between Lmax and Lr.

17. The decoating method according to claim 3, wherein LRmn is from 90% up to 100% of Lmax.
